(19) United States
(12) Patent Application Publication
(10) Pub. No.: US 2021/0357465 A1
(43) Pub. Date: Nov. 18, 2021

(54) Method and System for High Speed Serving of Webpages

(71) Applicant: Volusion, LLC, Austin, TX (US)

(72) Inventor: Santiago Oquendo Solano, Medellin (CO)

(73) Assignee: Volusion, LLC, Austin, TX (US)

(21) Appl. No.: 16/875,270

(22) Filed: May 15, 2020

(51) Int. Cl. G06F 16/958; G06F 16/9532; G06F 16/9538; G06F 16/957; G06F 16/16; G06F 12/0808; H04L 29/08

(52) U.S. Cl. CPC G06F 16/958; G06F 16/9532; G06F 16/9538; H04L 67/02; G06F 16/168; G06F 12/0808; G06F 16/9577

(57) ABSTRACT

Embodiments of the invention include a method and system for real time server-side rendering of webpages. When a request is received at a server from a requesting device for a webpage, the server queries a database for a logical page definition of the webpage responsive to the request. From the logical page definition, the server identifies a plurality of independent reusable blocks that collectively constitute the webpage. The server then renders each block of the plurality on the server to form a markup representation of the webpage in real time. The server then transmits the rendered markup representation of the page to the requesting device.

### BACKGROUND

### Technological Field

Embodiments of the invention relate to serving of webpages on a distributed network. Specifically, the embodiments of the invention relate to method and system for real time rendering of webpages to increase speed and usability on the distributed network.

### Background

The World Wide Web (the web) is ubiquitous in nearly all aspects of modern society. The Web consists of all publicly available websites. Generally, a website is a collection of publicly accessible, interlinked web pages that share a single domain name. Websites can be created and maintained by an individual, group, business or organization to serve a variety of purposes. For example, common websites include on-line stores, informational sites, entertainment sites among others.

Most websites today are dynamic. Responsive to an access request, the webserver uses a web application to obtain an html (hypertext markup language) template from a file system. The web application then obtains data from a database to populate the template and returns the populated template to the webserver to be sent on to the requesting browser. The webserver also sends along static resources such as cascading style sheets (CSS), Javascript images, and other static files. Another strategy commonly used, called Single Page Applications (SPA), only sends a basic markup and a collection of scripts that create the entire page markup in the browser by calling APIs to collect the data needed in the page. This is problematic as quality of service between the myriad devices that may access a site cannot be assured given the processing cost of generating the markup in the client device. To mitigate this problem, a combination of traditional server side rendering and adding more markup (in the client's browser) after the initial rendering is also used to add features such as reviews, blogs etc., as a result they fail to achieve reasonable search engine optimization (SEO) for those later added features.

Recognizing the challenge to achieve high speed for mobile devices, Google, Inc developed a protocol called Accelerated Mobile Pages (AMP) that provides a set of rules for mobile website development that results in improved speed on mobile devices. The rules are extremely restrictive and generally require a site developer to create and maintain two independent versions of the site resulting in full function when the sites loaded by for example a desktop computer and a light version with limited functions that loads rapidly on mobile devices. This increases development cost and diminishes the consistency of the feel provided to users on different platforms.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1 is a flow diagram of webserver operation according to one embodiment of the invention.

FIG. 2 is a flow diagram of handling a general page request in one embodiment of the invention.

FIG. 3 is a flow diagram of operation according to one aspect of the invention.

FIG. 4 is a flow diagram of AMP page handling according to one embodiment of the invention.

FIG. 5 is a block diagram of a system according to one embodiment of the invention.

FIG. 6 shows an example of a webpage generated consistent with an embodiment of the invention.

FIG. 7 is a representation of a webpage with a modal window open.

FIG. 8 shows a product webpage from an example e-commerce website.

### DETAILED DESCRIPTION

Embodiments of the invention employ a new and unique paradigm for real-time rendering of requested webpages that enhances the speed of service and improves search engine optimization over exiting methods. An understanding the improved method and system requires an understanding of certain foundational concepts.

Within the new paradigm, each webpage is formed from a plurality of independent reusable blocks (blocks). That is every webpage is an arranged collection of blocks. In one embodiment, a block represents a geographic area of the page and is responsible for the content displayed in that area. A logical representation of the page that sets forth identifiers of the included blocks and their arrangement within the page are retained in a database. The blocks are maintained in a block repository that may be in the same database or in a separate database. No markup representation of the page is retained on the webserver.

“Block” as used herein are 1) self-contained, that is they can be developed and used in isolation of other blocks; 2) contain markup and 3) contain a style. It is preferred that the markup be commonly available markup type rather than anything proprietary. In one embodiment, block markup is created in standard Javascript using a framework called React available from Facebook Inc. Similarly, the style in the form of a cascading style sheet (CSS) may use publicly available technology. For example, React markups can be styled using Aphrodite available from the Kahn Academy that provides a publicly available framework agnostic CSS in java script.

Additionally, blocks can fetch data from external data sources and communicate with other blocks. Preferably, blocks have a developer defined configuration that can be adjusted by a site owner after deployment. Additional information about creation of block-based web pages can be found in co-pending application entitled Platform and Method to Facilitate Website Development and Maintenance assigned to the applicant of the present application and filed on even date herewith. That application is incorporated herein by reference.

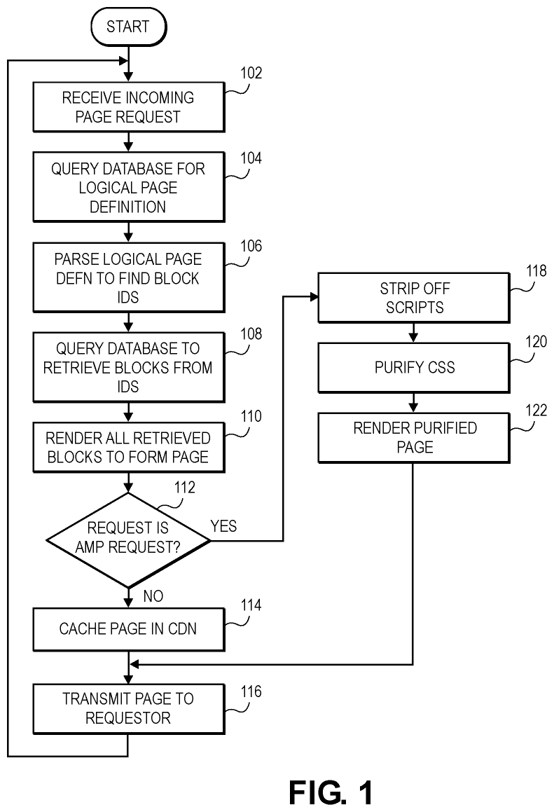

FIG. 1 is a flow diagram of webserver operation according to one embodiment of the invention. At functional element 102 a request for a webpage is received at the webserver. Typically, communication between clients and servers on distributed networks such as the world wide web (the web) use a standard communication protocol. Communication on the web are generally stateless using such as hypertext transfer protocol (http). As used herein http is deemed to include http, hypertext transfer protocol secure (https) and other existing or subsequently developed variants. On receipt of the request, the webserver analyzes the request to identify the requested page.

The webserver then queries a database for a logical page definition of the requested page at functional element 104. The logical page definition returned includes identifications of the blocks that form the page and arrangement information to tell the renderer, how the blocks should be arranged. The logical page definition does not include markup of the page. The webserver parses the logical page definition at functional element 106 to extract unique identifiers for the blocks in the page. Then, at functional element 108, the webserver queries a database to retrieve the blocks corresponding to the extracted identifiers.

At functional element 110, the server renders, in real-time, all constituent blocks and arranges them to form a markup version of the requested page. By completely rendering the page in the server, rather than relegating rendering to the browser, response time of the pages is improved. Moreover, because portion of the page such as reviews and blog entries are included in the page rendering, the search engine optimization (SEO) of the page is improved.

At decision element 112, the webserver determines if the request is an Accelerated Mobile Pages (AMP) request. If it is not an AMP request, then at functional element 114, the rendered page is cached in a content delivery network (CDN). The operation of CDN's is generally understood in the art. In principle, by caching a rendered page closer to a source of likely requests the page can be delivered faster on subsequent requests. CDN's generally use geographically distributed nodes to achieve physical proximity to likely requesters. After an initial page request, in some embodiments, the CDN may push the page to all nodes of the CDN. In other embodiments, the page may be cached only in the CDN node most proximate to the initial requester. Some embodiments may omit CDN caching entirely.

If at decision element 112 the request is found to be an AMP request, the server further process the mark up version created at functional element 110. The markup version is not assured to be AMP compliant. To try to assure AMP compliance, the server strips off all interactive scripts associated with the markup at functional element 118. The server then purifies the CSS of the of the page at functional element 120. AMP rules limit the size of CSS and preclude most scripting. By performing server-side script removal and CSS purification, the same blocks can be used in AMP and full function pages reducing required development effort. Once the page is purified, the server renders the purified page (which is AMP compliant if the blocks were develop as set forth above) at functional element 122. The purified page visually indistinct from how the page was rendered at functional element 110.

After rendering the purified page or caching the full function page in the CDN, the resulting page is transmitted to the requester at functional element 116. In the case of the full function page the requester will generally be a client node on the distributed network. In the case of the purified page the requestor will be a Google bot. The underlying technology of managing AMP pages within Google forms no part of this invention. Rather, embodiments of the invention facilitate deployment of AMP enabled websites.

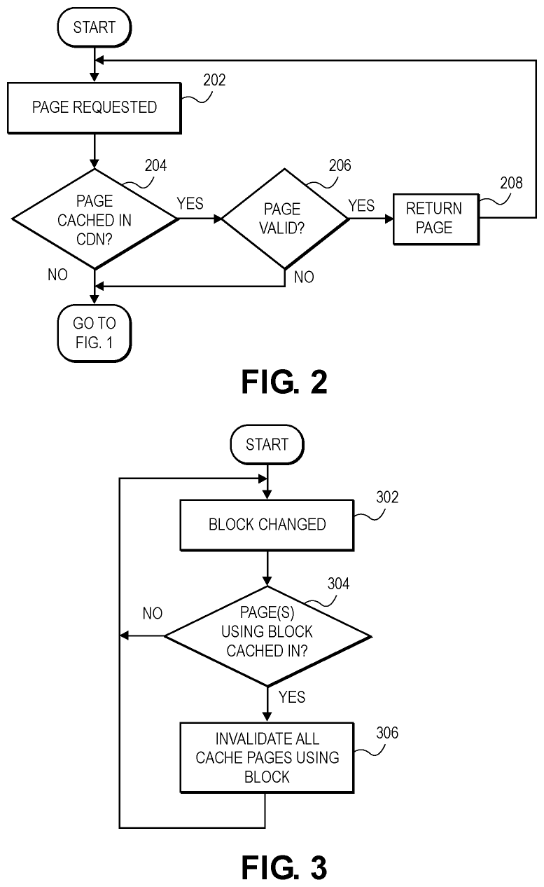

FIG. 2 is a flow diagram of handling a general page request in one embodiment of the invention. At functional element 202, a page request is received at a CDN node on the network. A determination is made, at decision element 204, if the page is cached at the CDN node. If it is cached, a determination is made, at decision element 206, whether the cached page is valid. If the cached page is valid, the page is returned directly to the requester from the CDN node at functional element 208. If the page is not present or invalid, the system follows the routine of FIG. 1 to supply the page to the requestor.

FIG. 3 is a flow diagram of operation according to one aspect of the invention. When a block that is used in one or more webpages is changed in a repository on the webserver, actions must be taken to ensure requestors receive the correct current data corresponding to the modified block. In different embodiments, changes to blocks may result from changes by a developer, or simply from modification of the configuration by the site owner. At functional element 302, a block modification occurs. A determination is then made at decision element 204 whether the modified block is present in any page or pages that have been cached in the CDN. If the modified block is used in cached pages, an invalidation event is sent to all nodes caching the page or pages at functional element 306. In this manner, the validity of data supplied responsive to a request will always reflect the current version of the blocks.

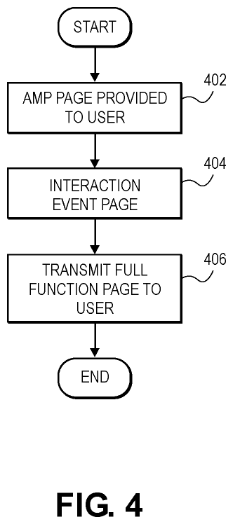

FIG. 4 is a flow diagram of AMP page handling according to one embodiment of the invention. Those skilled in the art will understand that the existence of AMP pages is largely transparent to end users. They may benefit from a faster user experience, but do not request AMP pages as such. Rather, when a mobile device requests a page if an AMP page is identified to exist it is supplied to provide a faster user experience. Supplying the AMP page to an end user does not access the host webserver and is instead handled by Google's underlying technology.

As discussed above, certain functionalities are removed from AMP pages in certain embodiment of the invention to ensure compliance of those pages with the AMP specification. Thus, while a pixel perfect version of the page is supplied to the requestor, most interactive functions are absent. Embodiments of the invention ensure a positive user experience by providing the experience of the full function page responsive to user interaction with the AMP page.

At functional element 402, an AMP page is provided to a user. At functional element 404, an interaction event is received through the webpage. For purposes of this discussion, an “interaction event” is any event that would have triggered an action from one of the scripts stripped off as part of the AMP page rendering. Responsive to the interaction event the full function page is provided to the user at functional element 406. The full function page can be provided by a proximate CDN node if a valid copy is present or it can be provided by the webserver consistent with the process discussed with reference to FIG. 1 above. Additionally, the specified action on the full function page will be invoked as part of the reload.

This process is generally transparent to the end user as provision of the full function page usually take no more (or only incrementally more) time than handling the interaction event. Moreover, the user benefits from the higher speed supply of the AMP page where no interactivity is desired. For example, if the user only views the page no interactivity event is generated, and the entire experience occurs at AMP speeds. Also as already noted the site owner benefits from not needing to maintain more than one version of the site (AMP and full function), by less restrictive development requirements for the “AMP” site and by providing greater consistency in user experience.

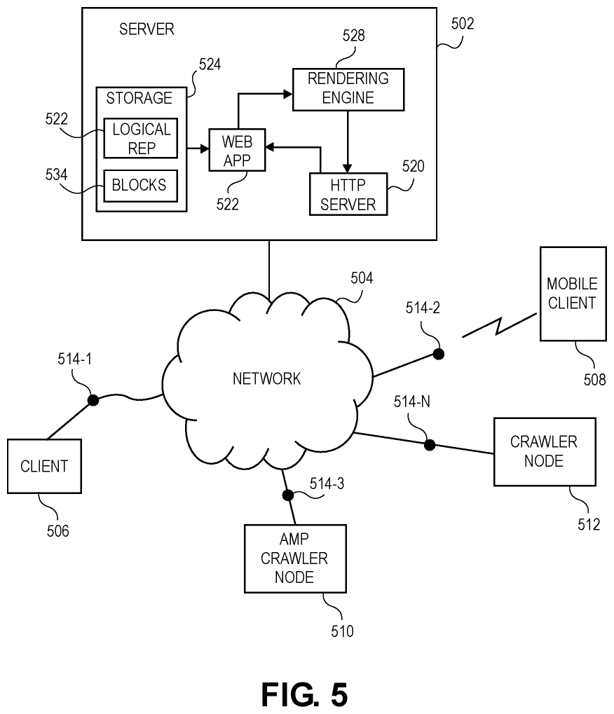

FIG. 5 is a block diagram of a system according to one embodiment of the invention. A server platform 502 resides as a node on a distributed network 504 such as the world wide web. The server platform 502 may include an http server 520 to send and receive http communications across the network 504. The server may also include a web application 522 that facilitates responses to requests for webpages received through the http server 520. The server platform includes a rendering engine 528 to perform real time rendering of webpages responsive to webpage requests.

Server 502 includes a storage unit 524 that retains blocks in a block repository 534 and logical representations of webpages in a logical page repository 532. Block repository 534 includes all of the published blocks that are available to the rendering engine 528 from which to create requested pages. Logical page repository 526 contains representations of all pages that the server platform is responsible for serving to webpage consumers. Storage unit 524 may be implemented as a single database or a plurality of databases.

The network includes numerous other client nodes such as for example wired client node 506, mobile client node 508, AMP crawler node 510, and crawler node 512. Wired client node 506 may be, for example, a desktop computer, a workstation, ethernet connected device or the like. Mobile client node 508 may be a wirelessly connected laptop, a tablet computer, a smartphone, an internet appliance, a phablet or similar devices that access the web via a wireless connection. Smartphones and tablets are likely to be the dominant consumers of AMP pages. Crawler node 512 is representative of the myriad automated indexing and archiving nodes present on the web today. Finally, AMP crawler node 510 is representative of the automated nodes responsible for identifying and serving AMP compliant pages to mobile devices. These nodes are merely exemplary of the types of nodes that may consume webpages. Substantially any webpage consumer could exist as a node on the network 504. Also on the network 504 are a plurality of CDN nodes 514-1, 514-2, 514-3, 514-N (generically 514). CDN nodes 514 operate in the traditional manner caching webpages in a geographically distributed manner to increase local availability and generally increase speed of service for geographically proximate consuming node.

Generally, when a webpage consumer e.g. mobile client 508 seeks to access a page the local CDN node 514-2 will provide the page if the page is cached and valid in the CDN node 514-2. If not, the request will be forwarded over the network 504 to the server platform 502. The http server 520 identifies the requested page and provides a page identifier to the web application 522. The web application queries the logical page repository 532 for the corresponding logical page representation. As discussed above, the logical page representation includes a list of blocks and arrangement information indicating how those blocks should be arranged. The web application 522 then queries the block repository 534 for the blocks that make up the webpage and passes the blocks with the arrangement information to the rendering engine 526. The rendering engine renders the blocks in real time and arranges them to form markup version of the requested page. The markup version is then sent via the http server 520 back to the requesting client in this example mobile client 508. CDN node 514-2 will also cache the page to service subsequent local requests.

If any of the blocks that make up any cached page in the CDN 514 are modified on the server, an invalidation event is sent to all CDN nodes 514 caching that page or pages. The CDN nodes 514 will invalidate the page or pages in the cache so that the next received request will receive the updated page rendered in real time on the server 502.

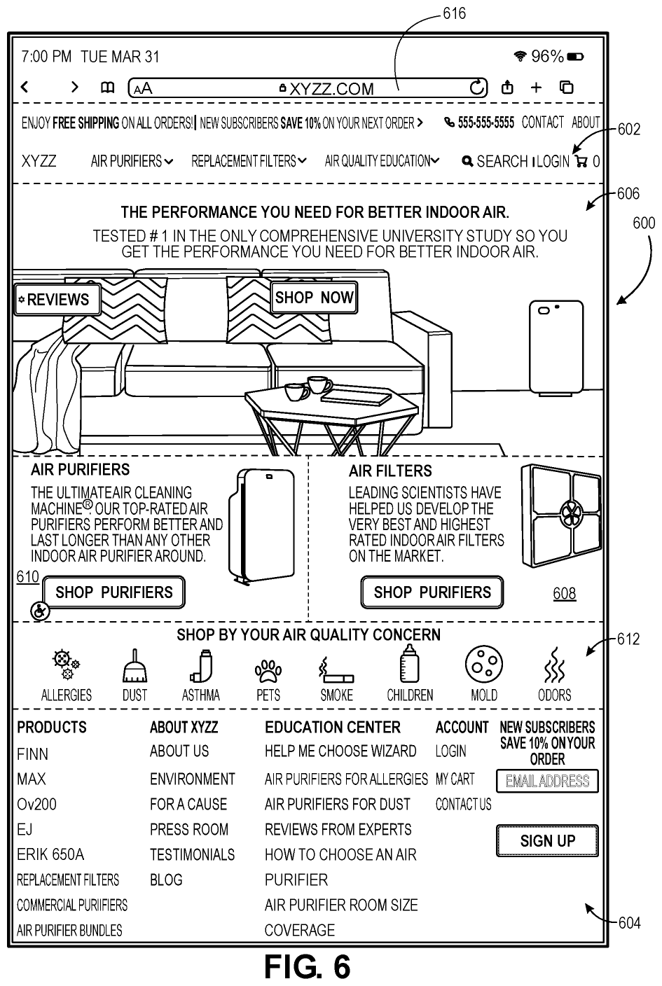

FIG. 6 shows an example of a webpage generated consistent with an embodiment of the invention. Presuming webpage 600 is not already cached in a CDN node, responsive to entering an address in a browser address bar, webpage 600 will be rendered in its entirety on the server and return to the browser. Browser could be any available internet browser including but not limited to Google Chrome®, Safari® from Apple Inc., Firefox®, Internet Explorer® from Microsoft Corp. etc. Entry of the webpage address into the address bar 616 may be done in any conventional manner.

Webpage 600 as shown includes six visible blocks each representing a nonoverlapping portion of the webpage. Webpage 600 may also include one or more modal window blocks that display only under defined conditions. It should be understood that use of six blocks is merely for purposes of example and more or fewer blocks could be used for any particular page. Also as previously discussed, the blocks can be freely used on different web pages. Here, a header block 602 and a footer block 604 are likely to be reused in most or all pages on a particular website.

In this example page 600 represents home page for an example e-commerce site. In addition to header block 602 and footer block 604 it also provides general store access block 606 that provides an entry point for shopping with out any category specification. Webpage 600 also includes two product line access blocks 608 and 610 and a product characteristic access block 612. Each of these blocks is stored and maintained separately on the server and only assembled into a page on request. Once the page resides in the browser, a user interacts with it in the normal way.

If webpage 600 has been loaded on a mobile device as an AMP page, it looks identical to the corresponding full function page. If a user does not interact with the page such as by use the back button on the browser or typing a new web address, the image remains until dismissed and no other action is required in background by the system. If on the other hand, a user interacts with the page such as by clicking on the “Reviews” button in block 606, that interaction triggers the block to cause the full function page to be loaded. In some embodiments Reviews may be a modal window that is included as part of webpage 600. In another embodiment the “Reviews” button may link to another page in the website. In the former case, the reloaded fully function page will appear with the Reviews modal window open. In the latter case, the full function page will be loaded and trigger the immediate retrieval of the Reviews page.

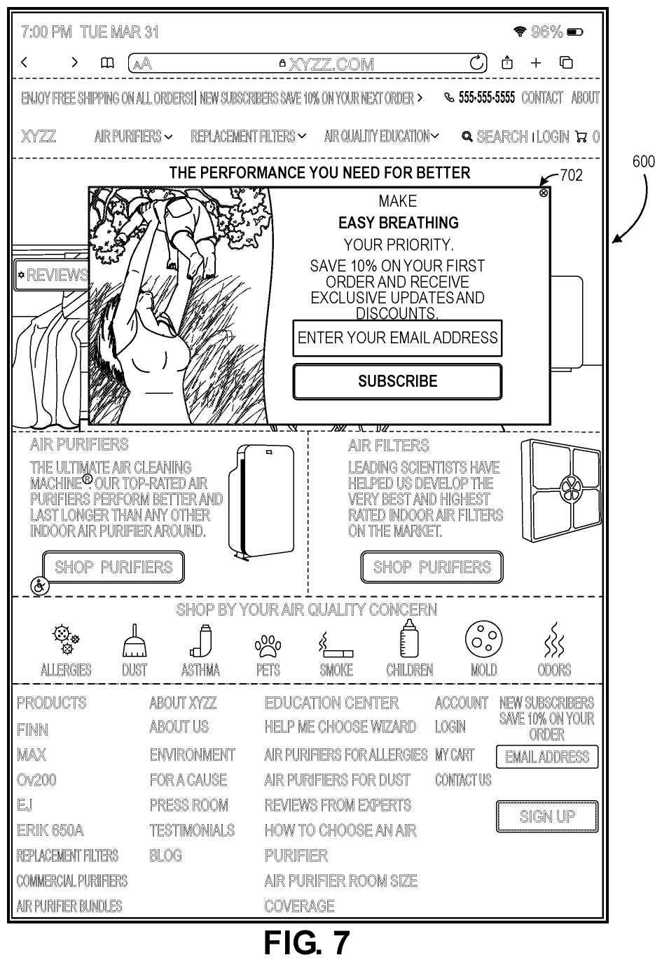

FIG. 7 is a representation of a webpage with a modal window open. Modal window 702 overlies the remainder of webpage 600 and is shown occluding the content of block 608. In some embodiments, modal windows are supported and are rendered on the server with the other blocks that form the page. Thus, the markup for the modal window e.g. modal window 702 is passed fully rendered to the browser. This has the benefit that content such as blogs and reviews whether instantiated as a modal window or as a content block within a page will be have improved search engine optimization (SEO) from former techniques that left the rendering of such content as an exercise for the browser.

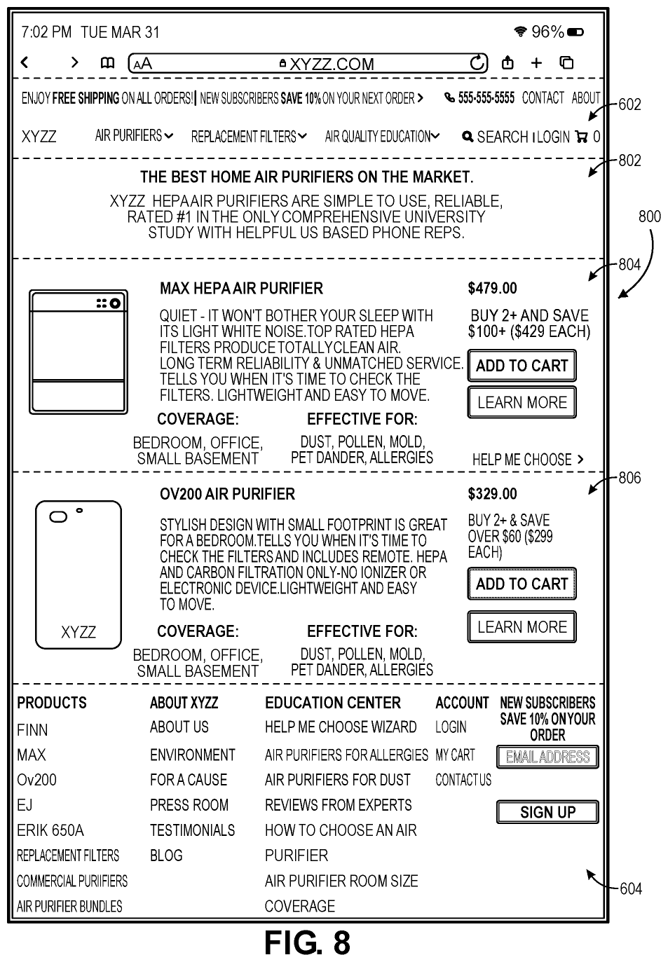

FIG. 8 shows a product webpage from an example e-commerce website. In one embodiment, page 800 could be reached by accessing the “SHOP PURIFIERS” link in the category block 610 of webpage 600. Webpage 800 is shown with five blocks. Header block 602 and footer block 604 are shared with webpage 600 (see FIG. 6). Webpage 800 also includes three unique blocks two product blocks 804, 806 and a text block 802. Again, the number of blocks in a page can be arbitrarily large. It should also be recognized that a particular page may not be entirely displayable on a single screen of the consuming device. By way of example, if the webpage included five product blocks it would be necessary to scroll through the products and e.g. header block 602 and footer block 604 would not be concurrently displayed. Nevertheless, the whole page is rendered on the server side independent of the amount of the page displayable at one time on the client.

While various aspect of embodiments of the invention are described with reference to flow diagrams, it should be understood that in some embodiments element of the flow diagrams may be performed in a different order or in parallel to rather than the order shown. Applicant expressly does not intend to imply a particular temporal relationship unless expressly stated in the claims that follow. Furthermore, to the extent that a decision element is included in the flow diagram, in some cases, that decision may be implicit or default. That is asynchronous selection of an execution path, e.g., interrupt driven, is within the scope and contemplation off embodiments of the invention.

In one embodiment, a system may be implemented as a combination of software and hardware devices. As noted, components may be implemented in software (e.g., microcode, assembly language or higher level languages). These software implementations may be stored on a machine-readable medium. A “machine readable” medium may include any medium that can store information. Examples of a machine readable medium include a ROM, a floppy diskette, a CD-ROM, a DVD, flash memory, hard drive, an optical disk or similar medium.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method of generating webpages comprising:
receiving a request at a server from a requesting device for a webpage;
submitting a database query for a logical page definition of the webpage responsive to the request;
identifying from the logical page definition a plurality of independent reusable blocks that collectively constitute the webpage;
rendering each block of the plurality on the server to form a markup representation of the webpage in real time;
transmitting the markup representation of the page to the requesting device.

2. The method of claim 1 further comprising:
submitting a database querying to retrieve the plurality of blocks based on unique block identifiers derived from the logical page definition.

3. The method of claim 1 further comprising:
receiving an AMP request over a distributed network;
rendering in real time on the server from the plurality blocks an AMP compliant page, the AMP compliant page substantially visually identical to an underlying full function page; and
serving the AMP compliant page to a node submitting the AMP request.

4. The method of claim 3 further comprising:
receiving an interaction request through the AMP compliant page; and
redirecting the interaction requesting device to the full function page responsive to the interaction request.

5. The method of claim 3 wherein rendering an AMP compliant page comprises:
stripping off interactive scripts from the full function page.

6. The method of claim 3 wherein rendering an AMP compliant page comprises:
purifying cascading style sheets that exists within the plurality of blocks.

7. The method of claim 3 wherein both the AMP page and the full function page are rendered from the same plurality of blocks.

8. The method of claim 1 wherein the markup version includes all content of the page such that no rendering of the page is relegated to the browser.

9. The method of claim 1 further comprising:
caching the page in a content delivery network (CDN); and
invalidating the cached copy responsive to a change release of any block of the plurality.

10. A machine-readable medium, having instructions stored therein, which when executed cause the machine to perform a set of operations to generate a webpage, the operations comprising:
receiving a request at a server from a requesting device for a webpage;
submitting a database query for a logical page definition of the webpage responsive to the request;
identifying from the logical page definition a plurality of independent reusable blocks that collectively constitute the webpage;
rendering each block of the plurality on the server to form a markup representation of the webpage in real time;
transmitting the markup representation of the page to the requesting device.

11. The machine-readable medium of claim 10, having further instructions stored therein, which when executed cause the machine to perform a further set of operations comprising:
submitting a database query to retrieve the plurality of blocks based on unique block identifiers derived from the logical page definition.

12. The machine-readable medium of claim 10, having further instructions stored therein, which when executed cause the machine to perform a further set of operations comprising:
receiving an Accelerated Mobile Pages (AMP) request over a distributed network;
rendering in real time on the server from the plurality blocks an AMP compliant page, the AMP compliant page substantially visually identical to an underlying full function page; and
serving the AMP compliant page to a node submitting the AMP validation request.

13. The machine-readable medium of claim 12, having further instructions stored therein, which when executed cause the machine to perform a further set of operations comprising:
receiving an interaction request through the AMP compliant page; and
redirecting the interaction requesting device to the full function page responsive to the interaction request.

14. The machine-readable medium of claim 12, wherein rendering the AMP compliant page includes:
stripping off interactive scripts from the full function page; and
purifying a cascading style sheet (CSS) that exists within at least one block of the plurality of blocks.

15. The machine-readable medium of claim 10, having further instructions stored therein, which when executed cause the machine to perform a further set of operations comprising:
caching the page in a content delivery network (CDN); and
invalidating the cached copy responsive to a change release of any block of the plurality.

16. A platform comprising:
a hyper-text transfer protocol (HTTP) server;
a first database section containing a plurality of logical page definitions corresponding to a plurality of webpages;
a second database section containing independent reusable blocks; and
a web application to retrieve and parse a logical page definition responsive to a request for a webpage from the plurality, the web application identifying from the parsing a subset of the reusable blocks to be rendered to create the requested page; and
a rendering engine to render the subset of reusable blocks in real time on the server to generate a markup representation of the requested page.

17. The platform of claim 16 wherein responsive to an identification of an incoming Accelerated Mobile Pages (AMP) request the rendering engine converts the markup representation to an AMP compliant page by, at least in part, stripping of interactive scripts from the markup representation of the page.

18. The platform of claim 16 wherein responsive to an identification of an incoming Accelerated Mobile Pages (AMP) validation request the rendering engine converts the markup representation to an AMP compliant page by, at least in part purifying a cascading style sheet associated with the page.

19. The platform of claim 17 wherein the HTTP server send the markup representation of the page to a user responsive to a user interaction event on the AMP compliant page.

20. The platform of claim 16 further comprising:
a content delivery network, the content delivery network caching previously requested of the plurality.
